(19) United States
(12) Patent Application Publication
(10) Pub. No.: US 2024/0221169 A1
(43) Pub. Date: Jul. 4, 2024

(54) IMAGE CROPPING PROCESSING METHOD, ELECTRONIC DEVICE, AND NON-TRANSITORY COMPUTER-READABLE RECORDING MEDIUM

(71) Applicant: COMPAL ELECTRONICS, INC., Taipei (TW)

(72) Inventors: HUI-MEI HUNG, Taipei (TW); PIN-YU CHOU, Taipei (TW); YUEH-HUA LEE, Taipei (TW); MING-HSIEN WU, Taipei (TW)

(21) Appl. No.: 18/393,731

(22) Filed: Dec. 22, 2023

Related U.S. Application Data
(60) Provisional application No. 63/435,814, filed on Dec. 29, 2022.

(51) Int. Cl. G06T 7/13; G06T 7/62; G06V 10/25

(52) U.S. Cl. CPC G06T 7/13; G06T 7/62; G06V 10/25; G06T 2207/20132; G06V 2201/07

(57) ABSTRACT

An image cropping processing method includes calculating a human body area ratio of the human covering area occupying an original size of an initial image, and defining a cropping area in the initial image according to a cropping ratio corresponding to the human body area ratio. Then, coinciding the center points according to the focal coordinate of the human body coverage area and the focal coordinate of the cropping area, and when the human body coverage area is covered within the cropping area in the initial image, the cropping area is selected to crop a cropped image with the proportion and position of the characters that meet the expectations of users. An electronic device of image cropping processing and a non-transitory computer-readable recording medium are utilized to perform the image cropping processing method.

### CROSS-REFERENCE TO RELATED APPLICATION

This non-provisional application claims priority under 35 U.S.C. § 119(e) on U.S. provisional Patent Application No. 63/435,814 filed on Dec. 29, 2022, the entire contents of which are hereby incorporated by reference.

### BACKGROUND OF THE INVENTION

### 1. Field of the Invention

The present disclosure provides an image processing technology, and in particular to an image cropping processing method, an electronic device, and a non-transitory computer-readable recording medium.

### 2. Description of the Related Art

As to conventional child monitoring systems, although the images captured by a photographic device can be selected by artificial intelligence, a problem is that the proportion of characters in the selected images is too small, or the position of the characters in the images is too marginal. Even though the bodies and expressions of characters present content worth collecting, they have a great chance of being eliminated during selection because the proportion and/or position of the characters in the initial image is not satisfactory. Even if selected, if the image is not processed artificially, the proportion and position of the characters in the image will not meet the expectations of users.

### BRIEF SUMMARY OF THE INVENTION

The present disclosure provides an image cropping processing method, an electronic device, and a non-transitory computer-readable recording medium, which can adjust the proportion and position of the characters in the initial image, so that the cropped image can meet the expectations of users.

In order to achieve the above objectives and more, the present disclosure provides an image cropping processing method, which is executed by an electronic device reading an executable code. When artificial intelligence identifies a human body in an initial image, a cropping processing to the initial image is executed. The process comprises the following steps: calculating a human body area ratio, calculating a cropping range, and focusing and cropping. The step of calculating a human body area ratio comprises:identifying a first upper boundary coordinate and a first lower boundary coordinate of the human body in the initial image and defining a human body coverage area for covering the human body, and defining a first focal coordinate of a center point of the human body coverage area, in order to calculate a human body area ratio of the human body coverage area occupying an original size of the initial image. The step of calculating a cropping range comprises: identifying a second upper boundary coordinate and a second lower boundary coordinate in the original size according to a cropping ratio corresponding to the human body area ratio to define a cropping area, and defining a second focal coordinate of a center point of the cropping area. The step of focusing and cropping comprises: coinciding the first focal coordinate and the second focal coordinate, when the human body coverage area is covered within the cropping area in the initial image, the cropping area is selected as a cropped image.

The present disclosure further provides an image cropping processing method, which is executed by an electronic device reading an executable code. When artificial intelligence determines that there are two or more human bodies identified in an initial image, cropping processing to the initial image is executed, including the following steps: calculating a human body area ratio, calculating a cropping range, and focusing and cropping. The step of calculating a human body area ratio comprises:identifying a first upper boundary coordinate and a first lower boundary coordinate of each the human body in the initial image, and taking a maximum longitudinal ordinate value and a minimum horizontal ordinate value to define a maximum upper boundary coordinate, and taking a minimum longitudinal ordinate value and a maximum horizontal ordinate value to define a maximum lower boundary coordinate, the maximum upper boundary coordinate and the maximum lower boundary coordinate are used to define a human body coverage area for covering all the human bodies, and defining a first focal coordinate of a center point of the human body coverage area, in order to calculate a human body area ratio of the human body coverage area in the initial image. The step of calculating a cropping range comprises: identifying a second upper boundary coordinate and a second lower boundary coordinate in an original size of the initial image according to a cropping ratio corresponding to the human body area ratio to define a cropping area, and defining a second focal coordinate of a center point of the cropping area. The step of focusing and cropping comprises: coinciding the first focal coordinate and the second focal coordinate, and when the human body coverage area is covered within the cropping area in the initial image, the cropping area is selected as a cropped image.

The present disclosure further provides an electronic device of image cropping processing, which is provided to connect to a database for communication. The electronic device receives an initial image and identifies a human body by artificial intelligence and is used to execute cropping processing to the initial image in order to complete a cropped image and transmit it to the database. The electronic device includes: a photographic unit and a processing unit. The photographic unit is for taking the initial image. The processing unit is electrically connected to the photographic unit. The processing unit includes: a human body area ratio calculation module, for identifying a first upper boundary coordinate and a first lower boundary coordinate of the human body in the initial image and defining a human body coverage area for covering the human body, and defining a first focal coordinate of a center point of the human body coverage area, in order to calculate a human body area ratio of the human body coverage area in the initial image. The processing unit further includes a cropping range calculation module, electrically connected to the human body area ratio calculation module, for identifying a second upper boundary coordinate and a second lower boundary coordinate in an original size of the initial image according to a cropping ratio corresponding to the human body area ratio to define a cropping area, and defining a second focal coordinate of a center point of the cropping area. The focusing and cropping module, electrically connected to the human body area ratio calculation module and the cropping range calculation module, is for coinciding the first focal coordinate and the second focal coordinate, and when the human body coverage area is covered within the cropping area in the initial image, the cropping area is selected as the cropped image.

In an embodiment, the step of calculating the human body area ratio includes setting an expansion value to shift the first upper boundary coordinate and the first lower boundary coordinate, so that the human body coverage area is expanded in equal proportion by the setting of the expansion value.

In an embodiment, the human body area ratio is proportional to the cropping ratio.

In an embodiment, an upper limiting value and a lower limiting value corresponding to the human body area ratio are set, and the cropping ratio is correspondingly scaled according to an interval size of the upper limiting value and the lower limiting value.

In an embodiment, before the step of calculating the human body area ratio, a preset value corresponding to the cropping ratio is set. In the step of calculating a cropping range, if the human body area ratio is greater than the upper limiting value, and the cropping ratio is less than or equal to the preset value, the cropping ratio is defined by the preset value. If the human body area ratio is greater than the upper limiting value, and the cropping ratio is greater than the preset value, the cropping ratio is defined between the preset value and the original size, or the cropping ratio is greater than or equal to the original size without cropping, or not cropped.

In an embodiment, in the step of focusing and cropping, when the first focal coordinate and the second focal coordinate coincide, if the human body coverage area exceeds the cropping area in a longitudinal direction or horizontal direction, the cropping area is expanded to the boundary that the human body coverage area exceeds in the longitudinal direction or horizontal direction, so as to meet the condition that the human body coverage area is covered within the cropping area.

In an embodiment, in the step of focusing and cropping, when the first focal coordinate and the second focal coordinate coincide, if the cropping area exceeds a longitudinal boundary and/or horizontal boundary of the original size, the cropping area shifts back according to the exceeded longitudinal boundary and/or horizontal boundary.

The present disclosure also provides a non-transitory computer-readable recording medium of the above-described method.

Accordingly, by the image cropping processing method and electronic device of the present disclosure, the cropping area is defined by the corresponding cropping ratio, and the center points are coincided by the focal coordinate of the human body coverage area and the focal coordinate of the cropping area, and the proportion and position of the characters can be adjusted for the initial image, so that the cropped image can meet the expectations of users.

### BRIEF DESCRIPTION OF THE DRAWINGS

FIG. 1 is a flow chart of the main steps of an image cropping processing method of an embodiment of the present disclosure.

FIG. 2 is a block diagram of an electronic device of an embodiment of the present disclosure.

FIG. 3 is a block diagram illustrating the steps of an image cropping processing method of an embodiment of the present disclosure.

FIG. 4 is a block diagram illustrating the process A of detecting a preset object of an embodiment of the present disclosure.

FIG. 5 is a block diagram illustrating the process B of detecting the preset object of an embodiment of the present disclosure.

FIG. 6 is a block diagram illustrating the process C of detecting the preset object of an embodiment of the present disclosure.

FIG. 7A is a schematic diagram of cropping of an embodiment of the present disclosure.

FIG. 7B is a schematic diagram of cropping of an embodiment of the present disclosure.

FIG. 7C is a schematic diagram of cropping of an embodiment of the present disclosure.

FIG. 7D is a schematic diagram of cropping of an embodiment of the present disclosure.

FIG. 7E is a schematic diagram of cropping of an embodiment of the present disclosure.

FIG. 7F is a schematic diagram of cropping of an embodiment of the present disclosure.

FIG. 8A is a schematic diagram of cropping of an embodiment of the present disclosure.

FIG. 8B is a schematic diagram of cropping of an embodiment of the present disclosure.

FIG. 8C is a schematic diagram of cropping of an embodiment of the present disclosure.

FIG. 8D is a schematic diagram of cropping of an embodiment of the present disclosure.

FIG. 9A is a schematic diagram of cropping of an embodiment of the present disclosure.

FIG. 9B is a schematic diagram of cropping of an embodiment of the present disclosure.

FIG. 9C is a schematic diagram of cropping of an embodiment of the present disclosure.

FIG. 10A is a schematic diagram of cropping of an embodiment of the present disclosure.

FIG. 10B is a schematic diagram of cropping of an embodiment of the present disclosure.

FIG. 10C is a schematic diagram of cropping of an embodiment of the present disclosure.

FIG. 11A is a schematic diagram of cropping of an embodiment of the present disclosure.

FIG. 11B is a schematic diagram of cropping of an embodiment of the present disclosure.

FIG. 11C is a schematic diagram of cropping of an embodiment of the present disclosure.

FIG. 12A is a schematic diagram of cropping of an embodiment of the present disclosure.

FIG. 12B is a schematic diagram of cropping of an embodiment of the present disclosure.

FIG. 12C is a schematic diagram of cropping of an embodiment of the present disclosure.

FIG. 13A is a schematic diagram of cropping of an embodiment of the present disclosure.

FIG. 13B is a schematic diagram of cropping of an embodiment of the present disclosure.

FIG. 13C is a schematic diagram of cropping of an embodiment of the present disclosure.

### DETAILED DESCRIPTION OF THE INVENTION

To facilitate understanding of the objectives, characteristics and effects of the present disclosure, specific embodiments together with the attached drawings for the detailed description of the present disclosure are provided as below.

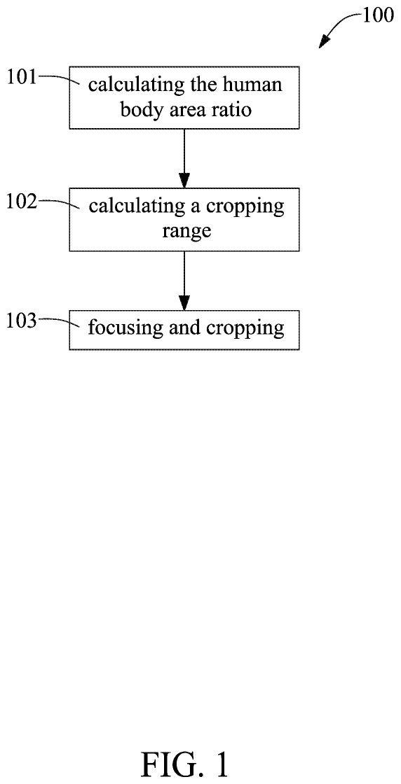

Referring to FIGS. 1 to 13C, the present disclosure provides an image cropping processing method 100, an electronic device 200, and a non-transitory computer-readable recording medium.

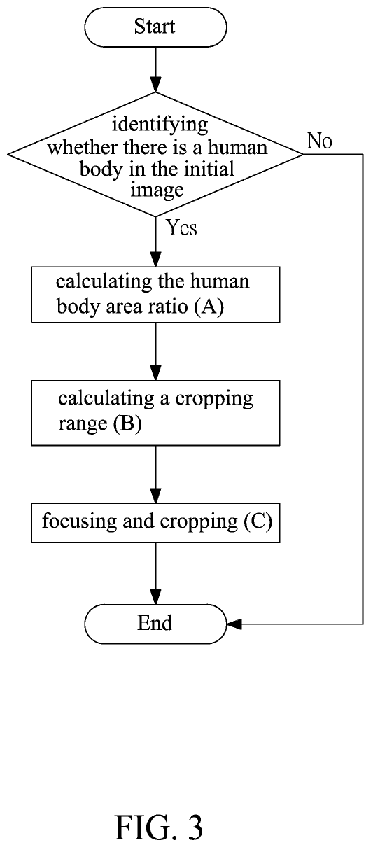

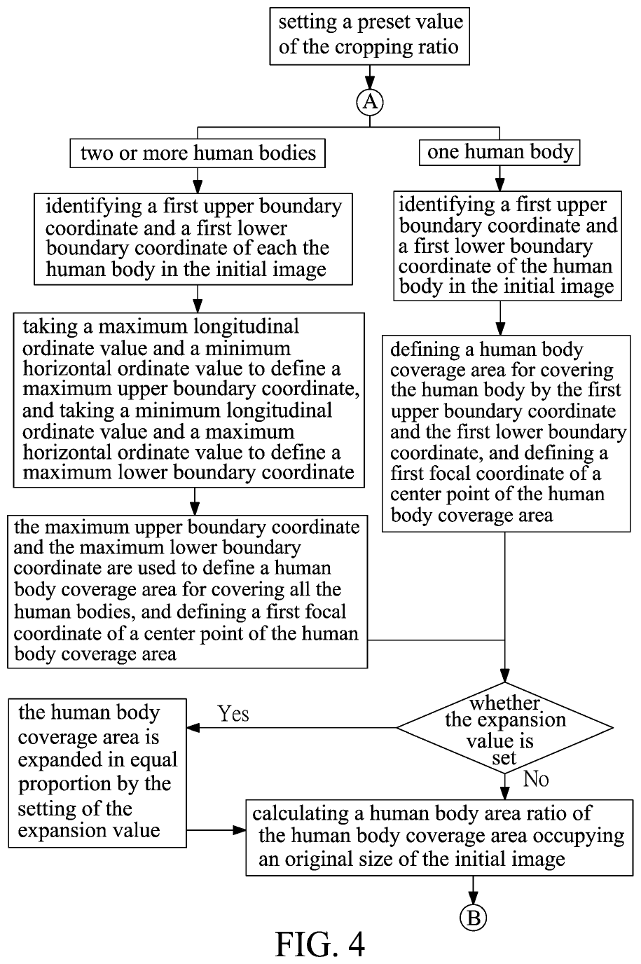

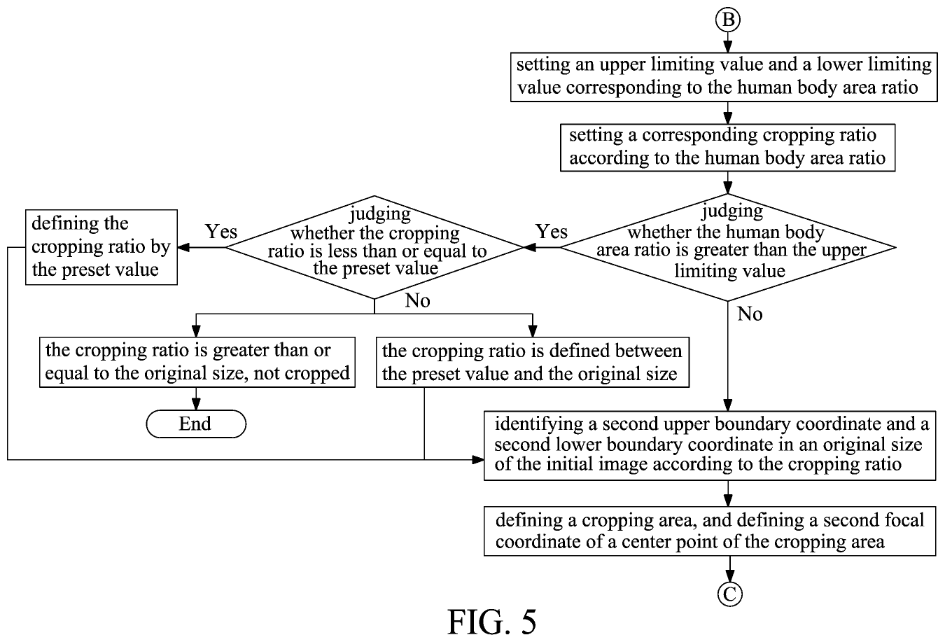

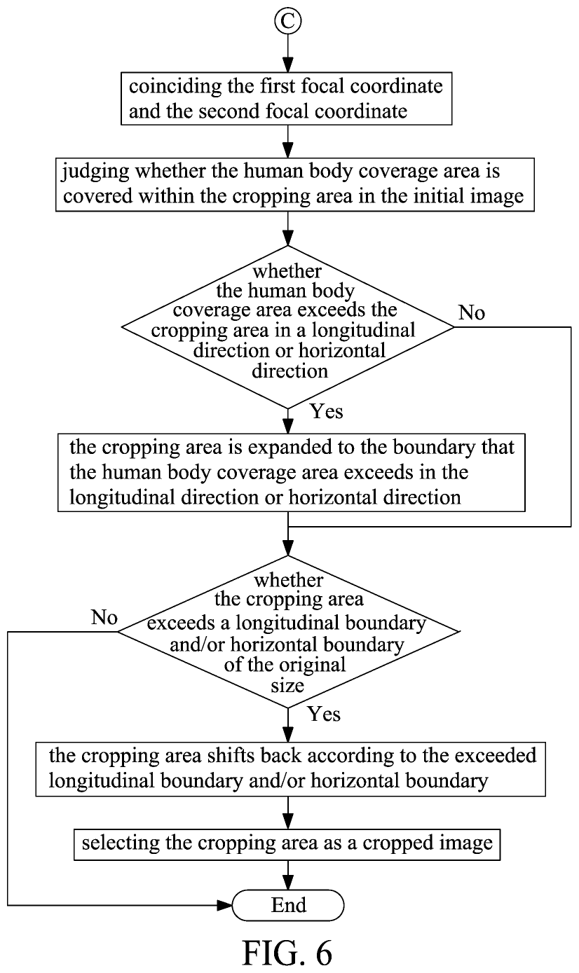

The image cropping processing method 100 is executed by the electronic device 200 reading an executable code, using artificial intelligence to identify whether there is a human body in an initial image V1. When there is a human body (one or more human bodies), the following steps are performed. Calculating a human body area ratio 101 (and marking process A in FIG. 3 to correspond to FIG. 4), calculating a cropping range 102 (and marking process B in FIG. 3 to correspond to FIG. 5), and focusing and cropping 103 (and marking process C in FIG. 3 to correspond to FIG. 6) as shown in FIG. 1 are executed, in order to execute cropping processing to the initial image V1. A plurality of executable codes executed by the image cropping processing method 100 may be stored in a non-transitory computer-readable recording medium, in order for the electronic device 200 to execute after reading the plurality of executable codes from the non-transitory computer-readable recording medium.

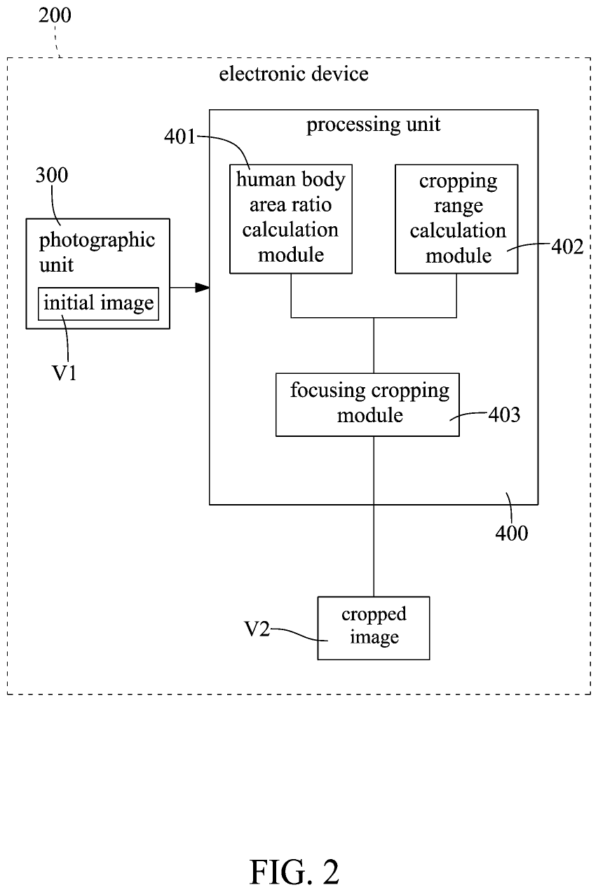

First, the electronic device 200 that executes the image cropping processing method 100 will be described. In an embodiment, as shown in FIG. 2, the electronic device 200 includes a photographic unit 300 and a processing unit 400. The photographic unit 300 is electrically connected to the processing unit 400. The processing unit 400 includes a human body area ratio calculation module 401, a cropping range calculation module 402, and a focusing and cropping module 403. The human body area ratio calculation module 401 is used to execute the step of calculating the human body area ratio 101. The cropping range calculation module 402 is used to execute the step of calculating a cropping range 102. The focusing and cropping module 403 is used to execute the step of focusing and cropping 103, so that the initial image V1 is cropped to a cropped image V2.

The electronic device 200 is a physical host and the electrically connected photographic unit 300 is disposed in the same body, but the present disclosure is not limited thereto, the electronic device 200 may also be a cloud host. The initial image V1 may be stored in a database (not shown in the figure), and the database may be a cloud server, or the database may also be a local server. The electronic device 200 is connected to the database for communication, the cropped image is completed after the electronic device 200 executing the image cropping processing method 100 transmits the cropped image to the database for storing and retrieving.

When executing the image cropping method 100, the step of calculating the human body area ratio 101 identifies a first upper boundary coordinate (x1,y1) and a first lower boundary coordinate (x2,y2) of the human body in the initial image V1 and defines a human body coverage area A1 for covering the human body, and defines a first focal coordinate (x3,y3) of a center point C1 of the human body coverage area A1, in order to calculate a human body area ratio of the human body coverage area A1 occupying an original size of the initial image V1. For example, the original size is 2592×1944 pixels, and the cropping ratio described in the following embodiment is compared with 100% of the original size.

In an embodiment, the step of calculating the human body area ratio 101 includes setting an expansion value to shift the first upper boundary coordinate and the first lower boundary coordinate, so that the human body coverage area A1 is expanded in equal proportion by the setting of the expansion value. For example, after calculating and obtaining the human body coverage area A1, the first upper boundary coordinate (x1,y1) and the first lower boundary coordinate (x2, y2) of the human body coverage area A1 are expanded up, down, left, and right. For example, by expanding the pixel value by 6%, it is preferable to respectively extend two lateral sides of the human body coverage area A1 by 80 pixels and the upper and lower sides are extended by 60 pixels each to avoid cutting the human body because of the alignment of the figure at each side of the human body coverage area A1 (e.g., in order to align the top of head, fingers, or soles of feet are cut).

After the step of calculating the human body area ratio 101 is executed, the step of calculating a cropping range 102 is executed. The execution of calculating a cropping range 102 is to identify a second upper boundary coordinate (x4, y4) and a second lower boundary coordinate (x5,y5) in the original size (2592×1944 pixels as described above) according to a cropping ratio corresponding to the human body area ratio obtained by the step of calculating the human body area ratio 101 to define a cropping area A2, and define a second focal coordinate (x6, y6) of a center point C2 of the cropping area A2. As shown in Table 1, in an embodiment, the cropping ratio is set to a minimum of 40%, and a maximum of 70%, when the human body area ratio is compared with a corresponding cropping ratio after calculation, a cropping area A2 is produced. In an embodiment, the human body area ratio is proportional to the cropping ratio, that is, when the human body area ratio is larger, the larger the cropping ratio. Conversely, when the human body area ratio is smaller, the smaller the cropping ratio.

Continuously, for example, as shown in Table 1 below, when the human body area ratio is less than 2%, the cropping ratio is set to 40%; when the human body area ratio is greater than or equal to 2% and less than 4%, the cropping ratio is set to 45%; when the human body area ratio is greater than or equal to 4% and less than 6%, the cropping ratio is set to 50%; when the human body area ratio is greater than or equal to 6% and less than 8%, the cropping ratio is set to 55%; when the human body area ratio is greater than or equal to 8% and less than 11%, the cropping ratio is set to 60%; and when the human body area ratio is greater than or equal to 11%, the cropping ratio is set to 70%.

TABLE 1

| the human body area ratio | cropping ratio |
|---|---|
| less than 2% (lower limiting value) | 40% |
| greater than or equal to 2%, less than 4% | 45% |
| greater than or equal to 4%, less than 6% | 50% |
| greater than or equal to 6%, less than 8% | 55% |
| greater than or equal to 8%, less than | 60% |
| 11% (upper limiting value) | |
| greater than or equal to 11% | If the cropping ratio after calculation is less |
| | than or equal to the preset value 70%, it is |
| | set to 70% |
| greater than or equal to 11% | If the cropping ratio after calculation is |
| | larger than the preset value 70%, it is set to |
| | 70-100% |

In an embodiment, corresponding to the step of calculating the human body area ratio 101, an upper limiting value and a lower limiting value corresponding to the human body area ratio are set, and the cropping ratio is correspondingly scaled according to an interval size of the upper limiting value and the lower limiting value. For example, in the human body area ratio described in the foregoing embodiment, the cropping ratio obtained after actual operation is 2% as the lower limiting value, and 11% as the upper limiting value. The interval between the upper limiting value and the lower limiting value and the cropping ratio is the interval between 40% and 70%, but this is only an embodiment, and the disclosure is not limited to the limits of the human body area ratio and the cropping ratio listed in this embodiment.

In an embodiment, before the step of calculating the human body area ratio 101, a preset value corresponding to the cropping ratio is set. In the step of calculating a cropping range 102, if the human body area ratio is greater than the upper limiting value, and the cropping ratio is less than or equal to the preset value, the cropping ratio is defined by the preset value. The preset value, for example, is set to 70% in an embodiment, so that if the human body area ratio of the preceding embodiment is greater than or equal to 11%, there are two situations. If the calculated cropping ratio is less than or equal to the preset value 70%, the cropping ratio is set to 70%. If the calculated human body area ratio is greater than the upper limiting value 11%, and the cropping ratio is greater than the preset value 70%, the cropping ratio is set between the preset value and the original size, for example, between 71-100%. If the calculated cropping ratio is quite close to 100%, the initial image may not be cropped, but output at a ratio of 100% of the original size.

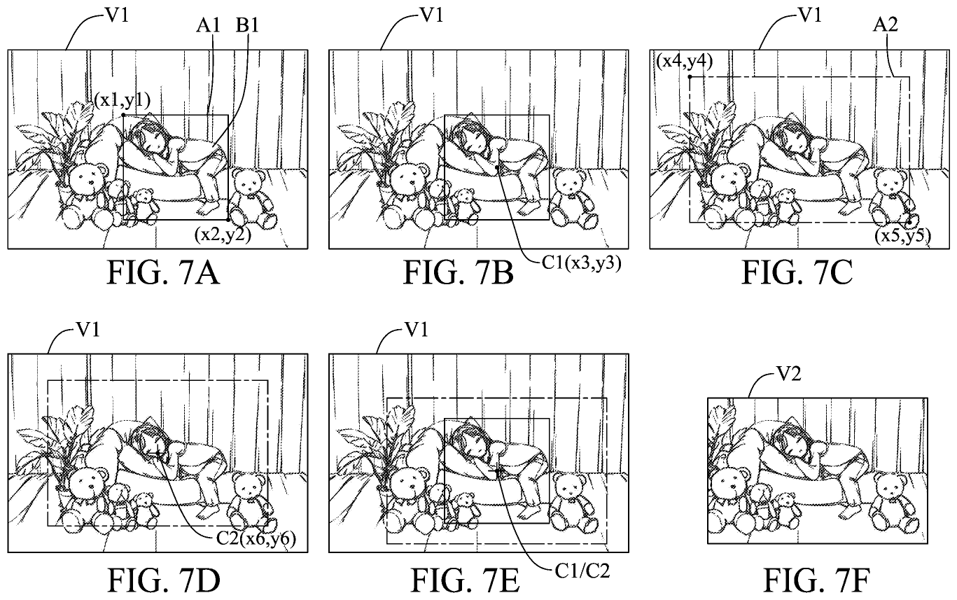

For example, FIGS. 7A to 7F are a first embodiment, the initial image V1 as shown in FIG. 7A includes a child human body B1, in the scene of the initial image V1, the child is lying on her stomach in a chair, and the original size of this initial image V1 is 2592×1944 pixels. Referring to the process A shown in FIG. 4 together, the preset value of the cropping ratio is 70%, the step of calculating the human body area ratio 101 is executed through the human body area ratio calculation module 401, and there is the human body B1 of the child identified by artificial intelligence, and then the first upper boundary coordinate (x1,y1) and the first lower boundary coordinate (x2,y2) of the human body B1 are identified in the initial image V1, and the first upper boundary coordinate (x1,y1) and the first lower boundary coordinate (x2,y2) are used to define a human body coverage area A1 for covering the human body B1, and an expansion value is set to 6% to the human body coverage area A1. Further, as shown in FIG. 7B, a first focal coordinate (x3,y3) of a center point C1 of the human body coverage area A1 is defined, and then a human body area ratio of the human body coverage area A1 occupying the original size (2592x 1944 pixels) of the initial image V1 is calculated. The human body area ratio is 18% in this embodiment, and then the step of calculating a cropping range 102 (process B) is performed.

Referring to the process B shown in FIG. 5 together, in the step of calculating a cropping range 102, an upper limiting value (e.g., 11%) and a lower limiting value (e.g., 2%) corresponding to the human body area ratio are set. Then the corresponding cropping ratio 70% is set according to the human body area ratio. At this time, the judgment result that the human body area ratio 18% is greater than the upper limiting value is “yes”, and the cropping ratio is judged to be equal to the preset value 70%, so the cropping ratio is defined by the preset value 70%. Further, as shown in FIG. 7C, in the original size of the initial image V1, a second upper boundary coordinate (x4, y4) and a second lower boundary coordinate (x5, y5) are identified, and as shown in FIG. 7D, a cropping area A2 is defined and a second focal coordinate (x6, y6) of a center point C2 of the cropping area A2 is defined, and then the step of focusing and cropping 103 (process C) is performed.

Referring to the process C shown in FIG. 6 together, in the step of calculating a cropping range 102, the first focal coordinate (x3,y3) and the second focal coordinate (x6,y6) coincide. At this time, as shown in FIG. 7E, the center point C1 of the human body coverage area A1 and the center point C2 of the cropping area A2 are concurrent, and the human body coverage area A1 is completely covered within the cropping area A2 in the initial image V1. That is to say, the judgment result that whether the human body coverage area A1 exceeds the cropping area A2 longitudinally or horizontally is no, and the result that whether the cropping area A2 exceeds the longitudinal boundary and/or horizontal boundary of the original size is also no, at this time, the cropping area A2 is used as a cropping range to be selected as a cropped image V2 (as shown in FIG. 7F).

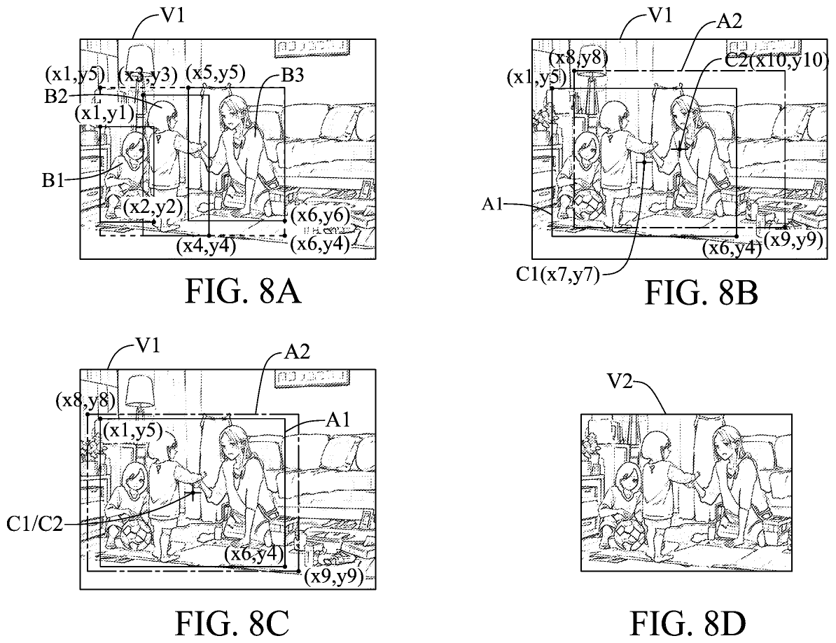

To give another example, FIGS. 8A to 8 D are a second embodiment, the initial image V1 as shown in FIG. 8A includes two child human bodies B1, B2 and an adult human body B3. In the scene of the initial image V1, one of the children is lying on the ground playing with a ball and the other child is playing a game with the adult. Referring to the process A shown in FIG. 4 together again, the preset value of the cropping ratio is also 70% and the step of calculating the human body area ratio 101 is executed through the human body area ratio calculation module 401. The human bodies B1, B2 and the adult human body B3 are identified by artificial intelligence, and then the first upper boundary coordinates and the first lower boundary coordinates of the human body B1, the human body B2, and the human body B3 are respectively identified in the initial image V1. The coordinates of the human body B1 are (x1,y1) (x2, y2), that of the human body B2 are (x3,y3) (x4, y4), and that of the human body B3 are (x5,y5) (x6,y6), in which a maximum longitudinal ordinate value y5 and a minimum horizontal ordinate value x1 are taken to define a maximum upper boundary coordinate (x1,y5), and a minimum longitudinal ordinate value y4 and a maximum horizontal ordinate value x6 are taken to define a maximum lower boundary coordinate (x6,y4). The maximum upper boundary coordinate (x1,y5) and the maximum lower boundary coordinate (x6,y4) are used to define a human body coverage area A1 for covering all of the human bodies B1, B2, and B3, and an expansion value is set to 6% to the human body coverage area A1. Further, as shown in FIG. 8 B, a first focal coordinate (x7,y7) of a center point C1 of the human body coverage area A1 is defined, and then a human body area ratio of the human body coverage area A1 occupying the original size (2592×1944 pixels) of the initial image V1 is calculated, the human body area ratio is 38% in this embodiment, and then the step of calculating a cropping range 102 (process B) is performed.

Referring to the process B shown in FIG. 5 together again, in the step of calculating a cropping range 102, an upper limiting value (e.g., 11%), and a lower limiting value (e.g., 2%) corresponding to the human body area ratio are set. Then the corresponding cropping ratio 70% is set according to the human body area ratio, at this time, the judgment result that the human body area ratio 38% is greater than the upper limiting value is “yes”, and the cropping ratio is judged to be equal to the preset value 70%, so the cropping ratio is defined by the preset value 70%. Further, as shown in FIG. 8B, in the original size of the initial image V1, a second upper boundary coordinate (x8, y8) and a second lower boundary coordinate (x9,y9) are identified, and a cropping area A2 is defined and a second focal coordinate (x10, y10) of a center point C2 of the cropping area A2 is defined, and then the step of focusing and cropping 103 (process C) is performed.

Referring to the process C shown in FIG. 6 together again, in the step of calculating a cropping range 102, the first focal coordinate (x7,y7) and the second focal coordinate (x10,y10) coincide, at this time, as shown in FIG. 8C, the center point C1 of the human body coverage area A1 and the center point C2 of the cropping area A2 are concurrent, and the human body coverage area A1 is completely covered within the cropping area A2 in the initial image V1. That is, the judgment result that whether the human body coverage area A1 exceeds the cropping area A2 longitudinally or horizontally is no, and the result that whether the cropping area A2 exceeds the longitudinal boundary and/or horizontal boundary of the original size is also no, at this time, the cropping area A2 is used as a cropping range to be selected as a cropped image V2 (as shown in FIG. 8D).

In the step of focusing and cropping 103, when the first focal coordinate (x3, y3) and the second focal coordinate (x6, y6) coincide, if the human body coverage area A1 exceeds the cropping area A2 in a longitudinal direction or horizontal direction, the cropping area A2 is expanded to the boundary that the human body coverage area A1 exceeds in the longitudinal direction or horizontal direction, so as to meet the condition that the human body coverage area A1 is covered within the cropping area A2.

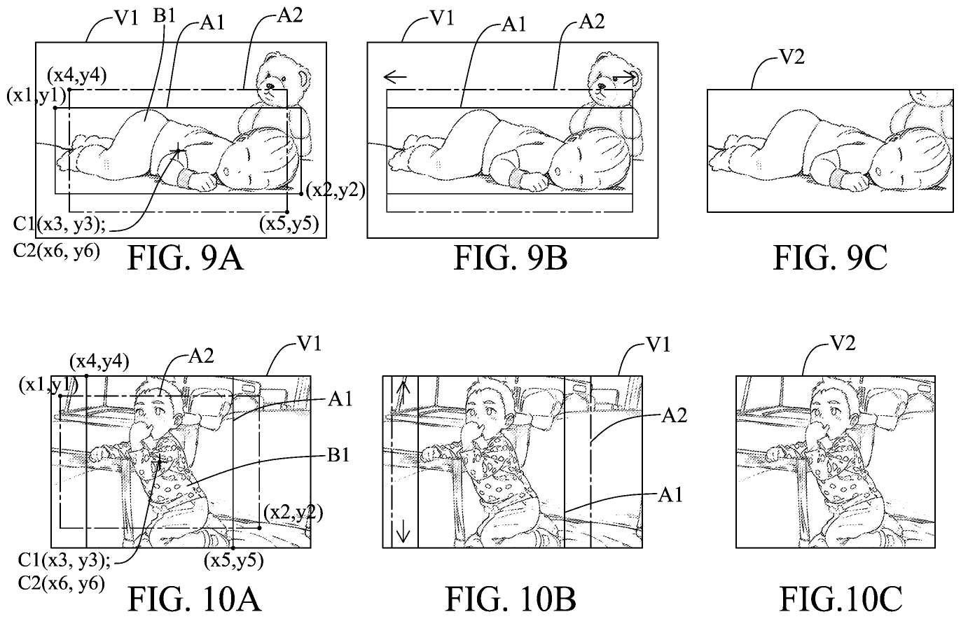

To give another example, FIGS. 9A to 9 C are a third embodiment, which executes the process C as in the first embodiment, and there is the human body B1 of the child identified in the initial image V1 by artificial intelligence. The first upper boundary coordinate (x1,y1) and the first lower boundary coordinate (x2, y2) of the human body B1 are identified after the step of calculating the human body area ratio 101, and then a human body coverage area A1 and a first focal coordinate (x3,y3) of a center point C1 are obtained. In the step of calculating a cropping range 102, the second upper boundary coordinate (x4, y4) and the second lower boundary coordinate (x5,y5) of the human body B1 are identified, and a cropping area A2 is defined and a second focal coordinate (x6,y6) of a center point C2 of the cropping area A2 is defined. In the step of focusing and cropping 103, when the first focal coordinate (x3, y3) and the second focal coordinate (x6,y6) coincide, the human body coverage area A1 exceeds a horizontal boundary of the cropping area A2 as shown in FIG. 9A, at this time, the cropping area A2 is expanded to the boundary that the human body coverage area A1 exceeds in the horizontal direction (as shown in FIG. 9B), so as to meet the condition that the human body coverage area A1 is covered within the cropping area A2, and after the step of the process C, the expanded cropping area A2 is used as a cropping range to be selected as a cropped image V2 (as shown in FIG. 9C).

Further, the fourth embodiment is shown as FIGS. 10A-10C, which executes the process C as in the third embodiment, and there is the human body B1 of the child identified in the initial image V1 by artificial intelligence. Then a human body coverage area A1 and a first focal coordinate (x3,y3) of a center point C1 and a second focal coordinate (x6,y6) of a center point C2 of the cropping area A2 are defined, and it differs from the third embodiment mainly in that the human body coverage area A1 exceeds a longitudinal boundary of the cropping area A2 as shown in FIG. 10A, at this time, the cropping area A2 is expanded to the boundary that the human body coverage area A1 exceeds in the longitudinal direction (as shown in FIG. 10B), so as to meet the condition that the human body coverage area A1 is covered within the cropping area A2. Similarly, after the step of the process C, the expanded cropping area A2 is used as a cropping range to be selected as a cropped image V2 (as shown in FIG. 10C).

In an embodiment, in the step of focusing and cropping 103, when the first focal coordinate (x3,y3) and the second focal coordinate (x6, y6) coincide, if the cropping area A2 exceeds a longitudinal boundary and/or horizontal boundary of the original size, the cropping area A2 shifts back according to the exceeded longitudinal boundary and/or horizontal boundary.

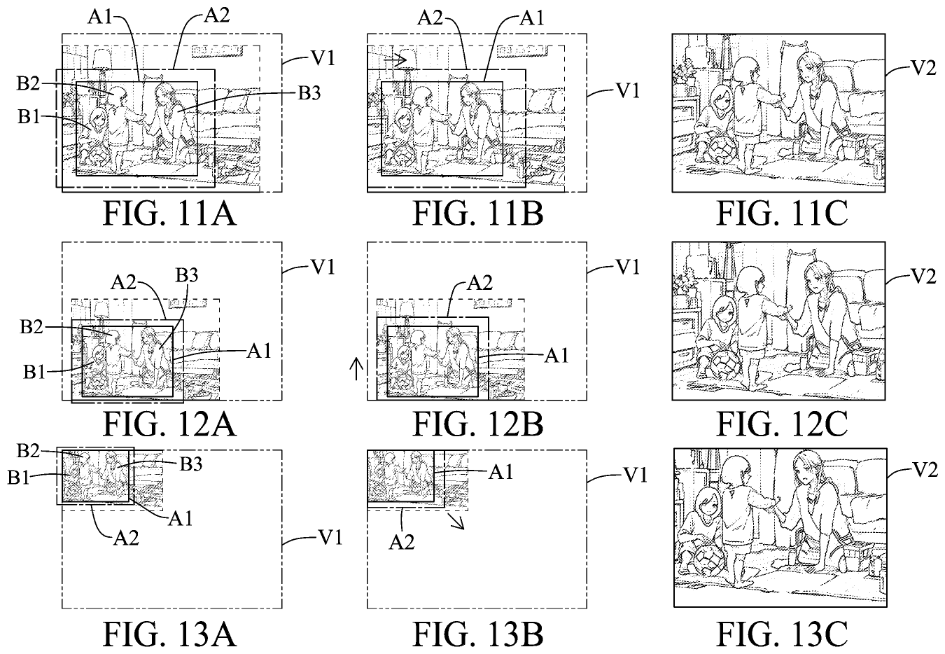

A fifth embodiment is shown in FIGS. 11A-11C, which executes the process C, and the human body B1 and the human body B2 of the children and the human body B3 of the adult are identified according to the initial image V1 by artificial intelligence. A human body coverage area A1 and a cropping area A2 are defined, wherein the human body area ratio is 45%, the cropping ratio is set to 70%. As shown in FIG. 11A, the left side of the cropping area A2 exceeds the horizontal boundary of the original size of the initial image V1 (the left boundary as shown in FIG. 11A). At this time, the cropping area A2 shifts back according to the exceeded horizontal boundary (shifting right as shown in FIG. 11B) to meet the conditions that the human body coverage area A1 is covered within the cropping area A2. Similarly, after the step of the process C, the shifted cropping area A2 is used as a cropping range to be selected as a cropped image V2 (as shown in FIG. 11C).

Further, a sixth embodiment is shown as FIGS. 12A-12C, which executes the process C, and there are the human body B1 and the human body B2 of the children and the human body B3 of the adult identified according to the initial image V1 by artificial intelligence. A human body coverage area A1 and a cropping area A2 are defined, wherein the human body area ratio is 11%, the cropping ratio is set to 70%. As shown in FIG. 12A, the lower side of the cropping area A2 exceeds the longitudinal boundary of the original size of the initial image V1 (the lower boundary as shown in FIG. 12A), at this time, the cropping area A2 shifts back according to the exceeded longitudinal boundary (shifting upwards as shown in FIG. 12B) to meet the conditions that the human body coverage area A1 is covered within the cropping area A2. Similarly, after the step of the process C, the shifted cropping area A2 is used as a cropping range to be selected as a cropped image V2 (as shown in FIG. 12C).

Further, a seventh embodiment is shown as FIGS. 13A-13C, which executes the process C, and the human body B1 and the human body B2 of the children and the human body B3 of the adult are identified according to the initial image V1 by artificial intelligence. A human body coverage area A1 and a cropping area A2 are defined, wherein the human body area ratio is less than 2% and the cropping ratio is set to 40%. As shown in FIG. 13A, the left side and upper side of the cropping area A2 exceed the horizontal and longitudinal boundaries of the original size of the initial image V1 (the upper left boundary as shown in FIG. 13A). At this time, the cropping area A2 shifts back according to the exceeded horizontal and longitudinal boundaries (shifting lower right as shown in FIG. 13B) to meet the conditions that the human body coverage area A1 is covered within the cropping area A2. Similarly, after the step of the process C, the shifted cropping area A2 is used as a cropping range to be selected as a cropped image V2 (as shown in FIG. 13C).

It is not difficult to find from the above description that the present disclosure is characterized in that by the image cropping processing method 100 and the electronic device 200 of the present disclosure, even if the position of the characters in the initial image V1 (such as children and/or an adult in the above embodiments) are too marginal, or there is a situation where the proportion of the character is too small, the human body (such as the human body B1-B3 in the above embodiments) of the character in the initial image V1 can be identified and detected by artificial intelligence to obtain the corresponding human body coverage area A1. According to the human body coverage area A1, the cropping area A2 is defined by the corresponding cropping ratio, and the center points C1/C2 coincide through the focal coordinate of the human body coverage area A1 and the focal coordinate of the cropping area A2, and the proportion and position of the characters are adjusted for the initial image V1, so that the cropped image V2 can meet the expectations of users.

While the present invention has been described by means of preferable embodiments, those skilled in the art should understand the above description is merely embodiments of the invention, and it should not be considered to limit the scope of the invention. It should be noted that all changes and substitutions which come within the meaning and range of equivalency of the embodiments are intended to be embraced in the scope of the invention. Therefore, the scope of the invention is defined by the claims.

What is claimed is:

1. An image cropping processing method, executed by an electronic device reading an executable code, when there is a human body identified in an initial image by artificial intelligence, cropping processing to the initial image is executed, comprising the following steps:
calculating a human body area ratio: identifying a first upper boundary coordinate and a first lower boundary coordinate of the human body in the initial image and defining a human body coverage area for covering the human body, and defining a first focal coordinate of a center point of the human body coverage area, in order to calculate a human body area ratio of the human body coverage area occupying an original size of the initial image;
calculating a cropping range: identifying a second upper boundary coordinate and a second lower boundary coordinate in the original size according to a cropping ratio corresponding to the human body area ratio to define a cropping area, and defining a second focal coordinate of a center point of the cropping area; and
focusing and cropping: coinciding the first focal coordinate and the second focal coordinate, when the human body coverage area is covered within the cropping area in the initial image, the cropping area is selected as a cropped image.

2. The image cropping processing method according to claim 1, wherein the step of calculating the human body area ratio comprises setting an expansion value to shift the first upper boundary coordinate and the first lower boundary coordinate, so that the human body coverage area is expanded in equal proportion by the setting of the expansion value.

3. The image cropping processing method according to claim 1, wherein the human body area ratio is proportional to the cropping ratio.

4. The image cropping processing method according to claim 3, wherein an upper limiting value and a lower limiting value corresponding to the human body area ratio are set, and the cropping ratio is correspondingly scaled according to an interval size of the upper limiting value and the lower limiting value.

5. The image cropping processing method according to claim 4, wherein before the step of calculating the human body area ratio, a preset value corresponding to the cropping ratio is set; and in the step of calculating a cropping range, if the human body area ratio is greater than the upper limiting value, and the cropping ratio is less than or equal to the preset value, the cropping ratio is defined by the preset value; and if the human body area ratio is greater than the upper limiting value, and the cropping ratio is greater than the preset value, the cropping ratio is defined between the preset value and the original size, or not cropped.

6. The image cropping processing method according to claim 1, wherein in the step of focusing and cropping, when the first focal coordinate and the second focal coordinate coincide, if the human body coverage area exceeds the cropping area in a longitudinal direction or horizontal direction, the cropping area is expanded to the boundary that the human body coverage area exceeds in the longitudinal direction or horizontal direction, so as to meet the condition that the human body coverage area is covered within the cropping area.

7. The image cropping processing method according to claim 6, wherein in the step of focusing and cropping, when the first focal coordinate and the second focal coordinate coincide, if the cropping area exceeds a longitudinal boundary and/or horizontal boundary of the original size, the cropping area shifts back according to the exceeded longitudinal boundary and/or horizontal boundary.

8. An image cropping processing method, executed by an electronic device reading an executable code, when there are two or more human bodies identified in an initial image by artificial intelligence, cropping processing to the initial image is executed, comprising the following steps:
calculating a human body area ratio: identifying a first upper boundary coordinate and a first lower boundary coordinate of each the human body in the initial image, and taking a maximum longitudinal ordinate value and a minimum horizontal ordinate value to define a maximum upper boundary coordinate, and taking a minimum longitudinal ordinate value and a maximum horizontal ordinate value to define a maximum lower boundary coordinate, the maximum upper boundary coordinate and the maximum lower boundary coordinate are used to define a human body coverage area for covering all the human bodies, and defining a first focal coordinate of a center point of the human body coverage area, in order to calculate a human body area ratio of the human body coverage area in the initial image;
calculating a cropping range: identifying a second upper boundary coordinate and a second lower boundary coordinate in an original size of the initial image according to a cropping ratio corresponding to the human body area ratio to define a cropping area, and defining a second focal coordinate of a center point of the cropping area; and
focusing and cropping: coinciding the first focal coordinate and the second focal coordinate, when the human body coverage area is covered within the cropping area in the initial image, the cropping area is selected as a cropped image.

9. The image cropping processing method according to claim 8, wherein the step of calculating the human body area ratio comprises setting an expansion value to shift the first upper boundary coordinate and the first lower boundary coordinate, so that the human body coverage area is expanded in equal proportion by the setting of the expansion value.

10. The image cropping processing method according to claim 8, wherein the human body area ratio is proportional to the cropping ratio.

11. The image cropping processing method according to claim 10, wherein an upper limiting value and a lower limiting value corresponding to the human body area ratio are set, and the cropping ratio is correspondingly scaled according to an interval size of the upper limiting value and the lower limiting value.

12. The image cropping processing method according to claim 11, wherein before the step of calculating the human body area ratio, a preset value corresponding to the cropping ratio is set; and in the step of calculating a cropping range, if the human body area ratio is greater than the upper limiting value, and the cropping ratio is less than or equal to the preset value, the cropping ratio is defined by the preset value; and if the human body area ratio is greater than the upper limiting value, and the cropping ratio is greater than the preset value, the cropping ratio is defined between the preset value and the original size, or the cropping ratio is greater than or equal to the original size without cropping.

13. The image cropping processing method according to claim 8, wherein in the step of focusing and cropping, when the first focal coordinate and the second focal coordinate coincide, if the human body coverage area exceeds the cropping area in a longitudinal direction or horizontal direction, the cropping area is expanded to the boundary that the human body coverage area exceeds in the longitudinal direction or horizontal direction, so as to meet the condition that the human body coverage area is covered within the cropping area.

14. The image cropping processing method according to claim 13, wherein in the step of focusing and cropping, when the first focal coordinate and the second focal coordinate coincide, if the cropping area exceeds a longitudinal boundary and/or horizontal boundary of the original size, the cropping area shifts back according to the exceeded longitudinal boundary and/or horizontal boundary.

15. An electronic device of image cropping processing, provided to connect to a database for communication, the electronic device receives an initial image and identifies a human body by artificial intelligence, and is used to execute cropping processing to the initial image, in order to complete a cropped image and transmit it to the database, the electronic device comprises:
a photographic unit, for taking the initial image; and
a processing unit, electrically connected to the photographic unit, the processing unit comprises:
a human body area ratio calculation module, electrically connected to the photographic unit, for identifying a first upper boundary coordinate and a first lower boundary coordinate of the human body in the initial image and defining a human body coverage area for covering the human body, and defining a first focal coordinate of a center point of the human body coverage area, in order to calculate a human body area ratio of the human body coverage area in the initial image;
a cropping range calculation module, electrically connected to the human body area ratio calculation module, for identifying a second upper boundary coordinate and a second lower boundary coordinate in an original size of the initial image according to a cropping ratio corresponding to the human body area ratio to define a cropping area, and defining a second focal coordinate of a center point of the cropping area; and
a focusing and cropping module, electrically connected to the human body area ratio calculation module and the cropping range calculation module, for coinciding the first focal coordinate and the second focal coordinate, and when the human body coverage area is covered within the cropping area in the initial image, the cropping area is selected as the cropped image.

16. A non-transitory computer-readable recording medium, storing a plurality of executable codes, after an electronic device reads the executable codes and executes, when there is a human body identified in an initial image by artificial intelligence, cropping processing to the initial image is executed, steps comprising:
calculating a human body area ratio: identifying a first upper boundary coordinate and a first lower boundary coordinate of the human body in the initial image and defining a human body coverage area for covering the human body, and defining a first focal coordinate of a center point of the human body coverage area, in order to calculate a human body area ratio of the human body coverage area in the initial image;
calculating a cropping range: identifying a second upper boundary coordinate and a second lower boundary coordinate in an original size of the initial image according to a cropping ratio corresponding to the human body area ratio to define a cropping area, and defining a second focal coordinate of a center point of the cropping area; and
focusing and cropping: coinciding the first focal coordinate and the second focal coordinate, and when the human body coverage area is covered within the cropping area in the initial image, the cropping area is selected as a cropped image.

17. A non-transitory computer-readable recording medium, storing a plurality of executable codes, after an electronic device reads the executable codes and executes, when there are two or more human bodies identified in an initial image by artificial intelligence, cropping processing to the initial image is executed, steps comprising:
calculating a human body area ratio: identifying a first upper boundary coordinate and a first lower boundary coordinate of each the human body in the initial image, and taking a maximum longitudinal ordinate value and a minimum horizontal ordinate value to define a maximum upper boundary coordinate, and taking a minimum longitudinal ordinate value and a maximum horizontal ordinate value to define a maximum lower boundary coordinate, the maximum upper boundary coordinate and the maximum lower boundary coordinate are used to define a human body coverage area for covering all the human bodies, and defining a first focal coordinate of a center point of the human body coverage area, in order to calculate a human body area ratio of the human body coverage area in the initial image;
calculating a cropping range: identifying a second upper boundary coordinate and a second lower boundary coordinate in an original size of the initial image according to a cropping ratio corresponding to the human body area ratio to define a cropping area, and defining a second focal coordinate of a center point of the cropping area; and
focusing and cropping: coinciding the first focal coordinate and the second focal coordinate, and when the human body coverage area is covered within the cropping area in the initial image, the cropping area is selected as a cropped image.
